(19) United States
(12) Patent Application Publication
(10) Pub. No.: US 2014/0279136 A1
(43) Pub. Date: Sep. 18, 2014

(54) BANDWIDTH AUCTIONING

(71) Applicant: Verizon Patent and Licensing Inc., Basking Ridge, NJ (US)

(72) Inventors: Dante J. Pacella, Charles Town, WV (US); Rudy Gohringer, Tampa, FL (US); Venkata Josyula, Ashburn, VA (US); Wen-De T. Chang, Chantilly, VA (US)

(73) Assignee: VERIZON PATENT AND LICENSING INC., Basking Ridge, NJ (US)

(21) Appl. No.: 13/837,467

(22) Filed: Mar. 15, 2013

(51) Int. Cl. H04L 12/24

(52) U.S. Cl. CPC H04L 41/5029
USPC 705/26.3

(57) ABSTRACT

A method, performed by a computer device, may include obtaining bandwidth use data associated with a network device and predicting a trough period in bandwidth use for the network device based on the obtained bandwidth use data. The method may further include providing an auction associated with a time period during the predicted trough period, wherein the auction offers use of the network device during the time period at a discounted price; receiving a bid, from a customer, for use of the network device during the time period via the auction; and provisioning one or more services on the network device for the customer based on the received bid, wherein the one or more services are provided for a duration of the auctioned time period.

### BACKGROUND INFORMATION

Networks may be designed for a particular bandwidth capacity. The cost to build a network may be predicated on peak usage, or near peak usage, of the bandwidth capacity. However, networks may experience intervals of idle bandwidth. For example, network usage may significantly decrease during off-hours. Intervals of idle bandwidth may represent inefficient usage of a network. Moreover, a network designed to handle traffic characterized by short bursts of high bandwidth use may not be cost-effective.

### BRIEF DESCRIPTION OF THE DRAWINGS

FIG. 1 is a diagram illustrating an exemplary environment according to an implementation described herein;

FIG. 2 is a diagram illustrating exemplary components of a network device of FIG. 1;

FIG. 3 is a diagram illustrating exemplary components of a device that may be included in one or more components of FIG. 1;

FIG. 4 is a diagram illustrating exemplary functional components of the network device of FIG. 1;

FIG. 5 is a diagram illustrating exemplary functional components of the bandwidth auctioning system of FIG. 1;

FIG. 6A is a diagram of exemplary components that may be stored in the bandwidth use database of FIG. 5;

FIG. 6B is a diagram of exemplary components that may be stored in the auction database of FIG. 5;

FIG. 7 is a flow chart of an exemplary process for collecting bandwidth data and provisioning services based on the bandwidth data according to an implementation described herein;

FIG. 8 is a flow chart of an exemplary process for bandwidth auctioning according to an implementation described herein; and

FIGS. 9A, 9B-1 to 9B-3, and 9C-9F are diagrams of an exemplary system that illustrates aspects of implementations described herein.

### DETAILED DESCRIPTION OF PREFERRED EMBODIMENTS

The following detailed description refers to the accompanying drawings. The same reference numbers in different drawings identify the same or similar elements.

An implementation described herein may relate to systems and methods of bandwidth auctioning, wherein cost of bandwidth use may be adjusted dynamically during trough periods to provide competitive pricing models while protecting return on investment for network operators. Network elements, such as, for example, switches, routers, reconfigurable optical add-drop multiplexers (ROADMs), may be configured to collect bandwidth use data over time. The bandwidth use data may be collected for particular interfaces of network devices, for particular queues, for particular Quality of Service (QoS) classes, for particular latency bounds, and/or for other types of traffic flow categorizations. The bandwidth use data may be sent to a bandwidth auctioning system.

The bandwidth auctioning system may analyze the bandwidth use data for a particular network device interface, queue, and/or QoS class and may identify troughs in the bandwidth use data. A trough, as the term is used herein, may refer to an interval in bandwidth use data wherein the bandwidth used is less than the maximum bandwidth capacity by at least a particular amount. For example, a link between two network devices may experience a first period of peak usage wherein 95 percent of the bandwidth capacity is used, followed by a second period wherein 30 to 60 percent of the bandwidth capacity is used, followed by a third period wherein 80-90 percent of the bandwidth capacity is used. The second period may be identified as a trough in bandwidth use.

The identified troughs in the bandwidth use data may be used to predict future troughs based on a periodicity of the identified troughs. For example, a trough in bandwidth use may occur during a particular period time during a day, may occur during a particular time period during a week, may occur during a particular time period during a month, may occur during a particular time period during a year, may occur on a particular date, and/or may occur with another type of periodicity.

An auction may be generated for a predicted future trough for a path through a network, the path being associated with particular network device interfaces, queues, and/or QoS classes, to sell the predicted unused bandwidth at a discounted price. Auctions may be generated for a link, or a set of links, from a first end point to a single second end point, from a first end point to multiple end points, and/or for multiple end point to multiple endpoint (mp2 mp) meshes. Furthermore, the unused bandwidth between a pair of end points, or between a mesh of network endpoints, may include aggregate or discrete parallel paths, such as link bundles, Equal Cost Multi-Path (ECMP) routes, a series of links along the path between the endpoints (e.g., A-B, B-C, C-D links for nodes A, B, and C along a path from endpoint A to endpoint B), or any combination thereof.

The bandwidth auctioning system may determine a starting price for the auction based on the market price of the path, based on the bandwidth use profile of the predicted trough, based on the length of time to the start of the predicted future trough, based on the length of time to the end of the predicted through period, and/or based on other factors. Customers may bid to purchase use of the predicted unused bandwidth during the predicted trough period.

A customer may bid for a particular amount of bandwidth use, such as a particular bitrate or a total number of bytes during a time period. Alternatively, the auction may be set for a particular bitrate or total number of bytes during a time period. Moreover, a customer may bid for a particular latency bound or a particular aggregate latency in the case of aggregate or discrete parallel paths, and/or may bid to include failover protection for the path. Furthermore, a customer may bid for provisioning of particular services on the path during the predicted future trough, such as, for example, provisioning of policers, access control lists (ACLs), label switched paths (LSPs), virtual local area networks (VLANs), and/or other types of services. Different services may be associated with different prices.

If no bids are received after a particular interval, the starting price may be decreased toward a minimum price. The minimum price may be based on a cost of running the auction, a cost of provisioning use of the unused bandwidth for a customer, and/or based on other factors. Once a particular threshold, for selling of unused bandwidth for a predicted future trough for a path, is reached, further auctions for the predicted future trough for the path may be suspended and/or auctions may be adjusted to reflect the market price for the path.

Once a customer has purchased a service for a path for a particular period of time, associated with a predicted future trough, one or more network devices, associated with the path, may be provisioned to provide the service for the customer. For example, the bandwidth auctioning system may instruct a network device to configure a particular interface, based on specifications received from the customer, at the beginning of the predicted trough period. The provisioning process may include the configuration of an enforcement mechanism for limiting the bandwidth use of the customer to a particular threshold. The enforcement may be strict, meaning that packets over the particular threshold are dropped, or loose, meaning that packets over the particular threshold may be subject to a higher price. Additionally or alternatively, enforcement mechanisms may include burst-size management and/or traffic shaping parameters. As an example, the enforcement mechanism may allow traffic bursts, which exceed the allowed bandwidth, of a particular size, duration, and/or frequency. As another example, traffic shaping parameters may be configured to assign traffic, which exceeds a bandwidth limit, to a lower priority class or to be dropped, if no lower priority class is available.

Furthermore, the provisioning mechanism may collect information for billing purposes. For example, the customer may pre-pay for a particular number of bytes, or a particular bitrate, and may be charged for traffic that exceeds the particular number of bytes or the particular bitrate. Moreover, when the particular time period, for which the customer has purchased use of the path, has ended, the one or more services may be de-provisioned and the customer may be provided with a bill or the fees may be aggregated based on an agreed upon interval (e.g., added to a monthly bill).

FIG. 1 is a diagram of an exemplary environment 100 in which the systems and/or methods described herein may be implemented. As shown in FIG. 1, environment 100 may include one or more customer devices 110-A and 110-N (referred to herein collectively as “customer devices 110” and individually as “customer device 110”), a network 120, and a bandwidth auctioning system 140.

Customer device 110 may include any device with a communication function, such as, for example, a personal computer or workstation; a server device; a portable computer; a printer, fax machine, or another type of physical medium output device; a television, a projector, a speaker, or another type of a display or audio output device; a set-top box; a gaming system; a camera, a video camera, a microphone, a sensor, or another type of input or content recording device; a portable communication device (e.g. a mobile phone, a smart phone, a tablet computer, a global positioning system (GPS) device, and/or another type of wireless device); a voice over Internet Protocol (VoIP) telephone device; a radiotelephone; a gateway, a router, a switch, a firewall, a Network Interface Card (NIC), a hub, a bridge, a proxy server, or another type of firewall device; a line terminating device, such as an add-drop multiplexer or an optical network terminal; a cable modem; a cable modem termination system; and/or any type of device with communication capability.

Network 120 may include one or more circuit-switched networks and/or packet-switched networks that enable customer devices 110 to communicate with each other. For example, network 120 may include a local area network (LAN), a wide area network (WAN), a metropolitan area network (MAN), an ad hoc network, an intranet, the Internet, a fiber optic-based network, a wireless network, and/or a combination of these or other types of networks.

Network 120 may include one or more network devices 130-A and 130-N (referred to herein collectively as “network devices 130” and individually as “network device 130”). Network device 130 may include any device that switches and/or routes traffic through network 120. For example, network device 130 may include a switch, a multi-port bridge, a router, a gateway, a firewall, and/or another type of packet-switched device. Alternatively, network device 130 may include an optical circuit-switched device, such as a ROADM, a digital cross connect (DXC) device, and/or or another type of optical device switching device. Network device 130 may collect information about bandwidth use relating to particular interfaces, queues, and/or QoS classes associated with network device 130 and may provide the collected information to bandwidth auctioning system 140. Furthermore, network device 130 may receive instructions from bandwidth auctioning system 140 to provision a service on a particular interface, queue, and/or QoS class for a particular time period based on a bid received on an auction.

Bandwidth auctioning system 140 may include one or more devices, such as server devices, computer devices, and/or storage devices, which collect bandwidth use data from network devices 130, analyze the collected bandwidth use data to identify troughs, and use the identified troughs to predict future troughs in bandwidth use. Bandwidth auctioning system 140 may generate an auction for a path, associated with one or more network device 130, based on a predicted future trough associated with the one or more network devices 130. In some implementations, the auction may be managed by bandwidth auctioning system 140. In other implementations, the auction may be managed by another system or group of devices (not shown in FIG. 1), such as a third party auctioning service. Thus, bandwidth auctioning system 140 may submit a request to run an auction for a predicted future trough for the path to the third party auctioning service.

Furthermore, bandwidth auctioning system 140 may receive a bid for a particular auction from a customer and may receive specifications for one or more services associated with the bid from the customer. Bandwidth provisioning system 140 may instruct one or more network devices 130, associated with the particular auction, to provision the one or more services based on the received specifications for the duration of a time period associated with the predicted future trough.

Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

FIG. 2 is a diagram illustrating example components of network device 130 of FIG. 1. As shown in FIG. 2, network device 130 may include one or more input ports 210-1 to 210-N (referred to herein individually as “input port 210” and collectively as “input ports 210”), a switching mechanism 220, one or more output ports 230-1 to 230-N (referred to herein individually as “output port 230” and collectively as “output ports 230”), and/or a control unit 240.

Input ports 210 may be the points of attachments for physical links and may be the points of entry for incoming traffic. As an example, input port 210 may be connected to an electrical cable capable of carrying a DS1 signal (or up to 24 DS0 signals), a DS3 signal (that may carry up to 28 DS1 signals), and/or any other type of cable. As another example, input port 210 may be connected to an optical cable.

Switching mechanism 220 may include one or more switching planes and/or fabric cards to facilitate communication between input ports 210 and output ports 230. In one implementation, each of the switching planes and/or fabric cards may include a single or multi-stage switch of crossbar elements. In another implementation, each of the switching planes may include some other form(s) of switching elements. Additionally or alternatively, switching mechanism 220 may include one or more processors, one or more memories, and/or one or more paths that permit communication between input ports 210 and output ports 230.

Output ports 230 may be the points of attachments for physical links and may be the points of exit for outgoing traffic. As an example, output port 230 may be connected to an electrical cable capable of carrying a DS1 signal (or up to 24 DS0 signals), a DS3 signal (that may carry up to 28 DS1 signals), and/or any other type of cable. As another example, output port 230 may be connected to an optical cable.

Each input port 210 and/or output port 230 may be associated with one or more interfaces. Each interface may communicate with an input port 210, or an output port 230, of another network device 130. Each interface may include one or more queues. Each queue of an input port 210 may store incoming packets of a particular category before the incoming packets are sent by switching mechanism 220 to a particular output port 230. Each queue of an output port 230 may store outgoing packets of a particular category before the outgoing packets are sent over a link to another network device 130. Each queue may be associated with one or more QoS classes. For example, each packet may be assigned to a QoS class, such as a voice communications QoS class, a video streaming QoS class, a real time gaming QoS class, an application signaling QoS class, a premium traffic QoS class, a best effort QoS class, a discard eligible QoS class, and/or another type of QoS class.

Control unit 240 may control the operation of switching mechanism 220. For example, control unit 240 may configure switching mechanism 220 to connect a particular input port 210 to a particular output port 230 to route a circuit from input port 210 to output port 230.

Although FIG. 2 shows example components of network device 130, in other implementations, network device 130 may include fewer components, different components, differently arranged components, and/or additional components than depicted in FIG. 2. Additionally or alternatively, one or more components of network device 130 may perform one or more tasks described as being performed by one or more other components of network device 130.

FIG. 3 is a diagram illustrating exemplary components of a device 300 according to an implementation described herein. Customer device 110, bandwidth auctioning system 140, switching mechanism 220 of network device 130, and/or control unit 240 of network device 130 may each include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some embodiments, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the customer. In some embodiments, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to radio frequency (RF) signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to collecting bandwidth use information, bandwidth auctioning, provisioning of services based on bandwidth auctioning, and/or other types of operations. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally or alternatively, one or more components of device 300 may perform one or more tasks described as being performed by one or more other components of device 300.

FIG. 4 is a diagram of exemplary functional components of network device 130. The functional components of network device 130 may be implemented, for example, via processor 320 executing instructions from memory 330 and may be installed on network device 130 by bandwidth auctioning system 140. Alternatively, some or all of the functional components of network device 130 may be hardwired. As shown in FIG. 4, network device 130 may include a bandwidth use database 410, a data collector 420, a provisioning mechanism 440, and a bandwidth auctioning system interface 430.

Bandwidth use database 410 may store information relating to bandwidth use associated with network device 130. For example, bandwidth use database 410 may store the bandwidth use data over time for particular interfaces, for particular queues associated with the particular interfaces, for particular QoS classes associated for particular queues, and/or other types of bandwidth use data. Data collector 420 may collect bandwidth use data associated with network device 130 and may store the collected bandwidth use data in bandwidth use database 410.

Provisioning mechanism 440 may provision one or more services on one or more interfaces of network device 130. For example, provisioning mechanism 440 may configure an interface based on specifications provided by customer in association with a bid for an auction. For example, provisioning mechanism 440 may configure one or more firewall filters for the interface, may configure an LSP for the interface, may configure a VLAN for the interface, and/or may perform another type of configuration on the interface. Furthermore, provisioning mechanism 440 may configure an enforcement mechanism and/or traffic shaping mechanism that manages traffic based on the specifications of an auction. For example, provisioning mechanism 440 may configure an enforcement mechanism to drop packets that exceed the purchased bandwidth, may configure an enforcement mechanism to allow traffic bursts of a particular size, duration, and/or frequency, may configure a traffic shaper to assign traffic that exceeds the purchased bandwidth to a lower priority class, and/or may perform other types of enforcement and/or traffic shaping configurations.

Bandwidth auctioning system interface 430 may communicate with bandwidth auctioning system 140. As an example, bandwidth auctioning system interface 430 may generate a message that includes bandwidth use data from bandwidth use database 410, may convert the message to a particular format compatible with bandwidth auctioning system 140, and may send the converted message to bandwidth auctioning system 140. As another example, bandwidth auctioning system interface 430 may receive a message including instructions from bandwidth auctioning system 140, may retrieve the instructions from the received message, and may provide the instructions to provisioning mechanism 440.

Although FIG. 4 shows exemplary functional components of network device 130, in other implementations, network device 130 may include fewer functional components, different functional components, differently arranged functional components, or additional functional components than depicted in FIG. 4. Additionally or alternatively, one or more functional components of network device 130 may perform functions described as being performed by one or more other functional components of network device 130.

FIG. 5 is a diagram of exemplary functional components of bandwidth auctioning system 140. The functional components of bandwidth auctioning system 140 may be implemented, for example, via processor 320 executing instructions from memory 330. Alternatively, some or all of the functional components of bandwidth auctioning system 140 may be hardwired. As shown in FIG. 5, bandwidth auctioning system 140 may include a network device interface 510, a bandwidth use database 520, a prediction module 530, a provisioning module 540, a price modeling module 550, an auctioning module 560, an auction database 570, and a billing module 580.

Network device interface 510 may communicate with network devices 130. As an example, network device interface 510 may receive bandwidth use data from network devices 130 at particular intervals. As another example, network device interface 510 may request bandwidth use data from network devices 130 at particular intervals. As yet another example, network device interface 510 may send instructions to network device 130 to provision a particular service during a particular time period.

Bandwidth use database 520 may store information relating to bandwidth use associated with particular network devices 130. Exemplary information that may be stored in bandwidth use database 520 is described below with reference to FIG. 6A. Prediction module 530 may analyze bandwidth use data associated with network device 130 to identify troughs in bandwidth use. Prediction module 530 may use the identified troughs to predict future troughs in bandwidth use for network device 130.

Provisioning module 540 may generate instructions for network device 130 to provision one or more services for a customer on network device 130 over a particular time period associated with a predicted future trough in bandwidth use. Price modeling module 550 may determine one or more prices for bandwidth use during a predicted future trough. For example, price modeling module 550 may determine a market price for a path that includes two or more network devices 130 and may determine a starting price, discounted with respect to the market price, for an auction for anticipated unused bandwidth during a predicted future trough for the path. Price modeling module 550 may further determine how to reduce the starting price over time toward a minimum price if no bids are received. The minimum price may be based on a cost of running an auction, a cost of provisioning services on network device 130, and/or based on other factors.

Auctioning module 560 may generate an auction for a predicted future trough. For example, auctioning module 560 may determine a path that includes two or more network devices 130 associated with a predicted future trough and may generate an auction that includes information about the predicted future trough, the available bandwidth during the predicted future trough, a starting price for the auction, and/or other information relating to the predicted future trough. In some implementations, auctioning module 560 may manage the generated auction.

In other implementations, auctioning module 560 may send a request to a third party auctioning service to run an auction based on the generated auction. In implementations that use a third party auctioning service, auctioning module 560 may provide, to the third party auctioning service, information that includes a set of links and/or paths; associated parameters, such as cost, latency, QoS, type of enforcement; time period or sub-period for predicted future troughs; available services for the set of links and/or paths; pricing profiles and/or price ranges; and/or other types of information that may be associated with an auction.

Auction database 570 may store information relating to particular auctions for selling use of bandwidth in network devices 130 during predicted future troughs. Exemplary information that may be stored in auction database 570 is described below with reference to FIG. 6B.

Billing module 580 may generate a bill for a customer that has bid on an auction generated by auctioning module 560. In some implementations, a customer may pre-pay for a particular bitrate or total number of bytes and packets that exceed the pre-paid bitrate or number of bytes may be dropped. In other implementations, a customer may bid for a particular rate and billing module 580 may keep track of the bitrate or number of bytes associated with the services provisioned for the customer and may bill the customer based on the particular rate. In yet other implementations, the customer may pre-pay for a particular bitrate or total number of bytes and packets that exceed the pre-paid bitrate or number of bytes may be billed to the customer. In some implementations, billing module 580 may generate a bill and bill the customer. In other implementations, billing module 580 may send billing information to a separate billing system and the billing system may generate the bill for the customer. The bill may include a report that includes information about the bid placed by the customer, information about how much bandwidth the customer used, and/or may include other information associated with the services provisioned for the customer.

Although FIG. 5 shows exemplary functional components of bandwidth auctioning system 140, in other implementations, bandwidth auctioning system 140 may include fewer functional components, different functional components, differently arranged functional components, or additional functional components than depicted in FIG. 5. Additionally or alternatively, one or more functional components of bandwidth auctioning system 140 may perform functions described as being performed by one or more other functional components of bandwidth auctioning system 140.

FIG. 6A is a diagram illustrating exemplary components that may be stored in bandwidth use database 520. As shown in FIG. 6A, bandwidth use database 520 may include one or more network device records 600 (referred to herein collectively as “network device records 600” and individually as “network device record 600”). Each network device record 600 may be associated with a particular network device 130. Network device record 600 may include a network device field 610 and one or more interface records 620 (referred to herein collectively as “interface records 620” and individually as “interface record 620”).

Network device field 610 may include information identifying a particular network device 130. For example, network device field 610 may include a name assigned to the particular network device 130, an address assigned to the particular network device 130 (e.g., an Internet Protocol (IP) address, a Media Access Control (MAC) address, etc.), and/or another type of identifier. Furthermore, network device field 610 may store information about the particular network device 130, such as a type of network device 130, a make and model of network device 130, software installed on network device 130, a list of active interfaces in network device 130, and/or other types of information about network device 130.

Interface record 620 may include information relating to a particular interface of the particular network device 130. Interface record 620 may include an interface field 622 and one or more queue records 630 (referred to herein collectively as “queue records 630” and individually as “queue record 630”). Interface field 622 may include information identifying the particular interface, such as a name of the particular interface, a type of the particular interface, a configuration of the particular interface, and/or other information associated with the particular interface.

Queue record 630 may include information relating to a particular queue associated with the particular interface. Queue record 630 may include a queue field 632 and one or more Quality of Service (QoS) class records 640 (referred to herein collectively as “QoS class records 640” and individually as “QoS record 640”). Queue field 632 may include information identifying a particular queue, such as a name of the particular queue, a type of the particular queue, and/or other information associated with the particular queue. QoS class record 640 may include information relating to a particular queue associated with the particular queue.

QoS class record 640 may include a QoS class field 642, a bandwidth data field 644, an identified troughs field 646, and one or more predicted troughs fields 650 (referred to herein collectively as “predicted troughs records 650” and individually as “predicted troughs record 650”). QoS class field 642 may store information identifying a particular QoS class, such as a voice communications QoS class, a video streaming QoS class, a real time gaming QoS class, an application signaling QoS class, a premium traffic QoS class, a best effort QoS class, a discard eligible QoS class, and/or another type of QoS class.

Bandwidth data field 644 may store information relating to the bandwidth use associated with the particular QoS class. For example, bandwidth data field 644 may store information about how much bandwidth was used during each sampling period over a particular time period. The bandwidth use data may be used to generate a plot of the bandwidth use over particular time periods, such as over a 24 hour period, over a week, over a month, over a year, and/or over another type of time period.

Identified troughs field 646 may store information about troughs that have been identified in the bandwidth use data stored in bandwidth data field 644. For example, for a particular identified trough, the information may identify a date and/or time at which the particular identified trough began, a bandwidth use profile during the particular identified trough, and a date and/or time at which the particular identified trough ended.

Predicted troughs record 650 may include information relating a particular predicted future trough. Predicted troughs record 650 may include a predicted trough field 652 and an available bandwidth profile field 654. Predicted trough field 652 may include information identifying a particular predicted future trough. For example, each predicted future trough may be assigned a unique identifier that may be used to identify the predicted future trough. Available bandwidth profile field 654 may include information relating to how much bandwidth is available during each period of the predicted future trough.

Although FIG. 6A shows exemplary components of bandwidth use database 520, in other implementations, bandwidth use database 520 may include fewer components, different components, differently arranged components, or additional components than depicted in FIG. 6A. As an example, in other implementations, each interface may include a single bandwidth use field that stores total bandwidth use for the interface. As another example, each queue for an interface may use a single bandwidth use field that stores total bandwidth use for the queue. As yet another example, an interface may include multiple QoS classes, each QoS class may include multiple queues, and each queue may be associated with a bandwidth use field that stores the bandwidth use data for the queue.

FIG. 6B is a diagram illustrating exemplary components that may be stored in auction database 570. As shown in FIG. 6B, auction database 570 may include one or more network device pair records 660 (referred to herein collectively as “network device pair records 660” and individually as “network device pair record 660”).

Each network device pair record 660 may store information relating to a particular pair of network devices 130 that are associated with a link for which an auction has been generated. Network device pair record 660 may include a network device pair field 662, and one or more auction records 670 (referred to herein collectively as “auction records 670” and individually as “auction record 670”). Network device pair field 662 may identify a first network device 130, associated with a first endpoint of a path, and a second network device 130, associated with a second endpoint of the path. Network devices 130 may be identified based on, for example, IP addresses (or another type of identifier) associated with network devices 130.

Each auction record 670 may identify a particular auction for bandwidth use on a particular path between the two network devices 130 of the particular pair. For example, each particular auction may be for a particular time period in a predicted future trough on a particular path between the two network devices 130. The particular path may include a series of links along the path, may include one or more link bundles that include multiple paths bundled together, may include an ECMP path, and/or may include any combination thereof.

Auction record 670 may include an auction field 672, a path field 674, a time period field 676, a bandwidth amount field 678, a remaining time field 680, a minimum price field 682, a starting price field 684, a market price field 686, a current bid field 688, and a final bid field 690. Auction field 672 may include an identifier (e.g., a string of characters) associated with the particular auction. Path field 674 may identify a particular path associated with the particular auction. For example, path field 674 may include a list of network devices 130, and associated interfaces, that make up the path from the first network device 130, of the network device pair, to the second network device 130, of the network device pair.

Time period field 676 may store information identifying the particular time period in the predicted future trough. For example, time period field 676 may identify the starting time and/or date for the particular time period and an ending time and/or date for the particular time period. Bandwidth amount field 678 may store information identifying the amount of available bandwidth for the auction. In some implementations, a customer may select a bandwidth amount, up to the total available bandwidth, on which to bid. In other implementations, an auction may be set for a particular bandwidth amount. Remaining time field 680 may store information identifying the amount of time that is remaining until the particular time period begins. The remaining time may be used to determine whether the starting bid price should be reduced as the particular time period approaches, if no bids have been received for the auction.

Minimum price field 682 may store information identifying the minimum price for the auction. Starting price field 684 may store information identifying a starting price for the auction. Market price field 686 may include information identifying the market price for the path. Current bid field 688 may store information identifying current bids associated with the particular auction. Final bid field 690 may store information identifying a final bid for the auction. For example, the auction may end when a particular amount of time remains before the particular time period begins, and the highest bid when the auction ends may be accepted as the final bid.

Although FIG. 6B shows exemplary components of auction database 570, in other implementations, auction database 570 may include fewer components, different components, differently arranged components, or additional components than depicted in FIG. 6B.

FIG. 7 is a flow chart of an exemplary process for collecting bandwidth data and provision services based on the bandwidth data according to an implementation described herein. In one implementation, the process of FIG. 7 may be performed by network device 130. In other implementations, some or all of the process of FIG. 7 may be performed by another device or a group of devices separate from network device 130 and/or including network device 130.

The process of FIG. 7 may include collecting bandwidth use data (block 710). For example, data collector 420 may collect bandwidth use data for particular interfaces, particular queues, and/or particular QoS classes of network device 130 and may store the bandwidth use data in bandwidth use database 410. The bandwidth use data may be collected at intervals that take into account anticipated microbursts. A microburst may correspond to a short burst of traffic. If bandwidth use data is sampled at a frequency or period that is longer than a length of a microburst, the bandwidth use data may not be accurate. Thus, the interval for collecting the bandwidth use data may be shorter than the average length of a microburst. Data collector 420 may determine an average length of a microburst by, for example, monitoring traffic through network device 130 over a particular length of time or by receiving information about an average length of a microburst from bandwidth auctioning system 140. The collected bandwidth use data may be provided to a bandwidth auctioning system (block 720). For example, data collector 420 may send data from bandwidth use database 410 to bandwidth auctioning system 140 via bandwidth auctioning system interface 430.

A provisioning request may be received from the bandwidth auctioning system for a particular time period (block 730) and one or more services may be provisioned based on the provisioning request at the start of the particular time period (block 740). For example, provisioning mechanism 440 may receive instructions from bandwidth auctioning system 140, via bandwidth auctioning system interface 430, to provision one or more services for a customer on one or more interfaces of network device 130 for a particular time period. As an example, the instructions may include instructions to configure an LSP in network 120 and to configure an input port 210 to forward packets, with a label associated with the LSP, to an output port 230. Furthermore, the instructions may include instructions to set up a set of firewall filters. The firewall filters may, for example, allow packets with a particular source addresses through while blocking packets from other source addresses, may drop packets that include a particular string of characters, etc. Furthermore, the instructions may include instructions to provision the one or more services at a first date and/or time and may include instructions to de-provision the services at a second date and/or time. The time period between the first date and/or time and the second date and/or time may correspond to a time period, within a predicted future trough, for which an auction has been generated and for which the customer has submitted a bid. Provisioning mechanism 440 may provision the one or more services based on the received instructions at the first date and/or time. Furthermore, provisioning mechanism 440 may configure an enforcement and/or traffic shaping mechanism based on the specifications of the auction. Thus, traffic that exceeds the specifications of the auction may be dropped or assigned to a lower priority class. Additionally or alternatively, bursts of traffic, which exceed the bandwidth specifications, that are of a particular size, duration, and/or frequency may be allowed.

Bandwidth use associated with the one or more services may be monitored during the particular time period (block 750) and information about the bandwidth use may be provided to a billing system (block 760). For example, data collector 420 may monitor bandwidth use associated with the provisioned one or more services (e.g., packets that include labels associated with a provisioned LSP path) and may, at particular intervals, send reports about the bandwidth use to bandwidth auctioning system 140. Bandwidth auctioning system 140 may use the received reports to bill the customer for the provisioned one or more services.

The one or more services may be de-provisioned at the end of the particular time period (block 770). For example, provisioning mechanism 440 may provision the one or more services based on the received instructions at the first date and/or time. Furthermore, data collector 420 may send a final report about the bandwidth use associated with the provisioned one or more services to bandwidth auctioning system 140.

FIG. 8 is a flow chart of an exemplary process for bandwidth auctioning according to an implementation described herein. In one implementation, the process of FIG. 8 may be performed by bandwidth auctioning system 140. In other implementations, some or all of the process of FIG. 8 may be performed by another device or a group of devices separate from bandwidth auctioning system 140 and/or including bandwidth auctioning system 140.

The process of FIG. 8 may include receiving bandwidth use data from a network (block 810). For example, network device interface 510 may receive bandwidth use data from network device 130 and may store the bandwidth use data in network device record 600, associated with network device 130, in bandwidth use database 410. Bandwidth use data may be received at particular intervals and network device record 600 may be updated whenever data is received.

The bandwidth use data may be analyzed to identify troughs (block 820). For example, prediction module 530 may analyze the bandwidth use data to identify troughs. Troughs may be identified using techniques such as smoothing the data and fitting a known polynomial to the smoothed data, detecting zero crossings in the slope of the data curve between a point and its neighbors, using wavelet-based peak detection, and/or using another technique. Troughs may be detected at different time scales. For example, troughs may be detected at an hourly time scale to identify troughs over a time period of a day, troughs may be detected at a daily time scale to identify troughs over a time period of a week and/or over a time period of a month, troughs may be detected at a longer time scale to identify troughs over a time period of a year, and/or troughs may be detected at a different time scale.

A future trough period may be predicted based on the identified troughs (block 830). For example, prediction module 530 may determine a periodicity for identified troughs at particular time scales. Thus, for example, prediction module 530 may determine that a trough occurs during a particular time of day, during particular days of the week, during particular days in a month, during particular times during a year, at particular dates in a year, etc. Prediction module 530 may generate a predicted trough record 650 for each predicted trough. Auctions may be generated for predicted future troughs.

One or more prices for the predicted future trough period may be determined (block 840). For example, price modeling module 550 may determine a starting price for an auction for a particular predicted trough. The starting price may be determined based on, for example, a market price for a path that includes network device 130 associated with the predicted trough, the amount of available bandwidth estimated for the predicted future trough, an estimated demand for bandwidth use during the predicted trough, based on a length of time to the start of the predicted trough, based on a length of time to the end of the predicted trough, and/or based on other factors. As an example, the starting price may be set below the market price in order to attract bids. As another example, the starting price may be set lower if the amount of anticipated available bandwidth is high in order to attract more bids and fill up the anticipated available bandwidth. The anticipated bandwidth may be high if the future predicted trough is large, based on a difference in bandwidth use between the predicted bandwidth use during the predicted future trough and peak bandwidth use (or the bandwidth capacity). As yet another example, if the anticipated demand is low, the starting price may be set low.

Furthermore, price modeling module 550 may determine a minimum price for an auction for a particular predicted trough. A minimum price may determine the lowest price at which the anticipated available bandwidth during the predicted future trough should be sold. The minimum price may be based on, for example, a cost of running an auction for the predicted future trough, a cost of provisioning services for a customer during the predicted future trough, a cost of billing the services, and/or based on other costs. Setting a minimum price may ensure that the unused bandwidth is not sold at a loss. Price modeling module 550 may set a price profile that decreased the starting price from the initial starting price to the minimum price over time if no bids are received. Thus, the starting price may be lowered as the time period of the predicted future trough approaches, if not bids are received.

One or more auctions may be generated for use of the network device during the predicted future trough period based on the determined one or more prices (block 850). For example, auctioning module 560 may generate an auction for the predicted future trough based on the determined one or more prices. The auction may be generated for a network device pair that includes a first network device, corresponding to a first end of the path, and a second network device, corresponding to a second end of the path, wherein the path includes network device 130 associated with the predicted future trough. For example, auctioning module 560 may match up predicted future troughs, associated with network devices 130 in the path, and may generate an auction for the path for the predicted future troughs. If predicted future troughs, associated with the network devices 130 in the path, do not match up exactly, auctioning module 560 may select a time period for which all the network devices 130 in the path are associated with a predicted future trough.

In some implementations, auctioning module 560 may host an auctioning service. In other implementations, the auctioning service may be hosted by a separate auctioning service and auctioning module 560 may send a request to the auctioning service to host the auction. The auction may be presented in a user interface that may be displayed to a customer when the customer requests to view auctions based on one or more criteria. For example, a customer may specify two locations (e.g., two cities) and a time period and may request to view auctions for available bandwidth between the two locations during the specified time period.

A bid, associated with one of the one or more auctions, may be received from a customer for a time period during the predicted future trough (block 860). For example, one or more customers may bid on the generated auction and at the end of the auction the highest bid price may be selected. In some implementations, a customer may select a bandwidth amount, up to the total available bandwidth, on which to bid. In other implementations, an auction may be set for a particular bandwidth amount. The auction may be maintained until the time set for the auction expires and/or until all anticipated available bandwidth during the predicted future trough has been sold based on received bids. When a customer bids on a particular bandwidth amount, the amount of available bandwidth may be reduced and the auction may continue until all the anticipated available bandwidth has been sold.

In other implementations, auctions for a predicted future trough may be terminated when it is determined that one or more bids for the auctions will increase bandwidth use during the predicted trough period by at least a particular amount. The particular amount may be less than the anticipated available bandwidth. Terminating the auctions when the particular amount of sold bandwidth is reached may ensure that a safety margin is included and that traffic congestion does not occur on the path.

In some implementations, a customer may bid for a service associated with a particular QoS class and different QoS classes may be associated with different prices. For example, a first price may be set for QoS classes that include a delivery guarantee, such as a premium traffic QoS class, a second price may be set for a best effort QoS class, and a third price may be set for a discard eligible QoS class (also referred to as a scavenger QoS class). In some implementations, a customer may bid for a service associated with a particular latency bound, or a particular aggregate latency bound, and different latency bounds may be associated with different prices. For example, a first price may be set for a first latency bound and a second price may be set for a second latency bound. In some implementations, a customer may bid to include failover protection for a particular path. Failover protection may guarantee an alternate path between the endpoints in case of link failure.

One or more specifications may be received from the customer (block 870). For example, after the customer has placed a bid, the customer may be prompted to provide one or more specifications for one or more services that the customer seeks to provision in connection with the bandwidth that the customer has purchased via the auction. The specifications may include, for example, one or more firewall filters (e.g., a policer filter, an access control list, etc.), an LSP specification, a VLAN specification, and/or another type of specification.

One or more services may be provisioned on the network device for the duration of the time period based on the one or more specifications received from the customer (block 880) and the customer may be billed for the one or more services (block 890). For example, provisioning module 540 may send instructions to all network devices 130 included in the path for which the user has bid. The instructions may include instructions to provision the one or more services at a first date and/or time and may include instructions to de-provision the services at a second date and/or time. The time period between the first date and/or time and the second date and/or time may correspond to the time period for which the auction was generated.

The customer may be billed for the auction. In some implementations, the customer may pre-pay for a particular bitrate or for a particular number of bytes. In other implementations, the customer may bid for a particular bitrate or a particular per-byte rate and may be billed at the end of the time period based on the bitrate or number of bytes used by the customer. In yet other implementations, the customer may be charged a first rate up to a particular threshold and may be charged a second rate above the threshold. For example, the customer may be charged a first per-byte rate for the first X bytes (e.g., a discounted rate based on the bid) and may be charged a second per-byte rate for bytes after the first X bytes (e.g., a market rate for the path).

FIGS. 9A-9F are diagrams of an exemplary system that illustrates aspects of implementations described herein. FIG. 9A is a diagram of an exemplary system 901. As shown in FIG. 9A, system 901 may include a first customer network 910-A and a second customer network 910-B, associated with a first customer. System 901 may further include a second customer device 915-A, a second customer device 915-B, and a second customer device 915-C, associated with a second customer. Moreover, system 901 may include a network device 920-A, which may connect first customer network 910-A, second customer device 915-A, and second customer device 915-B to network 120; network device 920-B, which may connect first customer network 910-B to network 120; and network device 920-C, which may connect second customer device 915-C to network 120.

Furthermore, three paths may exist from network device 920-A to network device 920-B in network 120; a first path through provider network 930-A, a second path through provider network 930-B, and a third path through provider network 930-C. Network device 920-C may be included in provider network 930-C and path 925 may exist between network device 920-A and network device 920-C.

FIGS. 9B-1, 9B-2, and 9B-3 are diagrams of bandwidth use data that may be collected for path 925 between network device 920-A and network device 920-C. The data may be collected by network device 920-A for an interface associated with path 925, by network device 920-C for an interface associated with path 925, or by both network device 920-A and network device 920-C. Path 925 may correspond to a single link between network device 920-A and network device 920-C, may correspond to a set of links between network device 920-A and network device 920-C, or may correspond to a set of aggregate or discrete parallel paths between network device 920-A and network device 920-C.

FIG. 9B-1 illustrates a plot 940 of bandwidth use for a 24 hour period. Plot 940 may include a first trough 940-A between the hours of 11 PM and 7 AM, a second trough 940-B between the hours of 12 PM and 4 PM, and a third trough 940-C between the hours of 7 PM and 9 PM. FIG. 9B-2 illustrates plot 942 of bandwidth use for a period of one week. Plot 942 may include a trough 942-A during the weekend days of Saturday and Sunday. FIG. 9B-3 illustrates plot 944 of bandwidth use over a period of one year. Plot 944 may include troughs 944-A, 944-D, and 944-E, which may correspond to drops in traffic during holidays, trough 944-B, which may correspond to a drop in traffic over the month of May, and trough 944-D, which may correspond to drop in traffic over the summer months. The troughs in FIGS. 9B-1, 9B-2, and 9B-3 may be periodic in nature and may thus be used to predict future troughs in bandwidth use for path 925. For example, an auction may be generated to sell the anticipated unused bandwidth associated with trough 942-A over the weekend.

FIG. 9C is a diagram of exemplary user interfaces 950 and 955 associated with auctions for use of path 925. As shown in FIG. 9C, interface 950 may correspond to a user interface that may be presented to a customer when the customer accesses an auctioning service. Interface 950 may display auctions for bandwidth use on links between New York and Washington, D.C. for time periods starting on Feb. 8, 2013. The listed auctions may include three auctions corresponding to paths through provider network 930-A, provider network 930-B, and provider network 930-C. The customer may select to bid on one of the auctions based on the offered starting price. Assume the first customer, associated with first customer network 910-A and first customer network 910-B, bids on a path from network device 920-A to network device 920-B through provider network 930-C. The bidded-upon path may include path 925.

Interface 955 may correspond to a user interface that may be presented to a customer in response to the customer requesting to search for auctions that meet particular criteria. Assume the second customer, associated with customer device 915-A, a second customer device 915-B, and a second customer device 915-C, desires a connection from second customer device 915-A to second customer device 915-B and to second customer device 915-C. The second customer may select to view auctions for multiple endpoints from New York to Baltimore for the time period from Feb. 8, 2013 to Feb. 11, 2013. Assume the second customer bids on an auction for a path that includes path 925.

FIG. 9D is a diagram of a plot 960 of the auction price for path 925 over time and a corresponding plot 965 of available bandwidth over time as the auction progresses. As shown in FIG. 9D, plot 960 may include a plot of the auction price for path 925 over time. Plot 960 illustrates the market price, the starting price, and the minimum price. As time progresses and no bids are received, the starting price may be automatically dropped by particular amounts toward the minimum price. The first customer may place a first bid at some later time. Plot 965 shows the available bandwidth associated with path 925. After the first bid is accepted, the available bandwidth may be reduced by the amount purchased by the first customer.

After the first bid, the bid price for the remaining bandwidth on path 925 may be raised. At a later time, the second customer may bid on the remaining bandwidth on path 925. Plot 965 shows that after the second bid is accepted, no bandwidth remains available for the predicted future trough associated with path 925. Therefore, all auctions associated with the predicted future trough, associated with path 925, may be terminated.

FIG. 9E is a diagram of system 901 after provisioning of path 925 based on auctions. As shown in FIG. 9E, system 901 may include a first service provisioned for the first customer. The first service may include an LSP 970 set up between first customer network 910-A and first customer network 910-B through provider network 930-C using path 925. Furthermore, system 901 may include a second service provisioned for the second customer. The second service may include a VLAN 975 set up between second customer device 915-A, second customer device 915-B and second customer device 915-C via path 925.

FIG. 9F is a diagram of network device 920-A after provisioning of path 925 for LSP service 970 for the first customer and VLAN service 975 for the second customer, based on the auctions. Path 925 may be connected to port 985-1. Furthermore, first customer network 910-A may be connected to port 980-1, second customer device 915-A may be connected to port 980-3, and second customer device 915-B may be connected to port 980-5. The provisioning of the LSP for the first customer may include configuration 990, which may include updating a forwarding table of network device 920-A to send packets received at port 980-1, and including a label associated with LSP service 970, to port 985-1. The provisioning of VLAN 975 may include configuration 992 and 994, which may include updating the forwarding table of network device 920-A to exchange packets, which include a VLAN tag associated with VLAN 975, between port 980-1, port 980-3, and port 980-5.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while implementations have been described with respect to bandwidth auctioning, other implementations may relate to auctioning of another type of underused computing resource. For example, other implementations may relate to auctioning of cloud computing resources. Cloud computing centers may collect information relating to the use of cloud computing resources, such as central processing unit (CPU) computing time, memory use, use of a particular application, use of a particular platform, and/or use of another type of resource available via a cloud computing center. A cloud computing resource auctioning system may collect information relating to the cloud computing resources, may analyze the collected information for troughs in the use of a particular resource or for other types of decrease in the anticipated use of the particular resource, and may determine future predicted troughs in the particular resource in a particular cloud computing center.

The cloud computing resource auctioning system may generate an auction to sell the use of the particular resource during the predicted future trough at a discounted price, with respect to a market price. The cloud computing resource auctioning system may receive a bid from a customer for the use of the particular resource during the predicted future trough, may receive specifications from the customer for provisioning the particular resource, and may provision the particular resource for the customer during the predicted future trough.

As another example, while series of blocks have been described with respect to FIGS. 7 and 8, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method performed by one or more computer devices, the method comprising:
obtaining, by the one or more computer devices, bandwidth use data associated with a network device;
predicting, by the one or more computer devices, a trough period in bandwidth use for the network device based on the obtained bandwidth use data;
providing, by the one or more computer devices, an auction associated with a time period during the predicted trough period, wherein the auction offers use of the network device during the time period at a discounted price;
receiving, by the one or more computer devices, a bid, from a customer, for use of the network device during the time period via the auction; and
provisioning, by the one or more computer devices, one or more services on the network device for the customer based on the received bid, wherein the one or more services are provided for a duration of the auctioned time period.

2. The method of claim 1, wherein obtaining the bandwidth use data includes at least one of:
obtaining bandwidth use data for a particular interface associated with the network device;
obtaining bandwidth use data for a particular queue associated with the network device; or
obtaining bandwidth use data for a particular quality of service class associated with the network device.

3. The method of claim 1, wherein predicting the trough period in bandwidth use for the network device includes:
identifying a trough in the bandwidth use data, wherein the trough occurs at a particular frequency; and
predicting the trough period based on the particular frequency.

4. The method of claim 1, wherein providing the auction associated with a time period during the predicted trough period includes:
setting a starting price for the discounted price, wherein the starting price is based on a difference in bandwidth use between a predicted bandwidth use during the predicted trough period and a peak bandwidth use.

5. The method of claim 4, further comprising:
setting a minimum price for the discounted price based on a cost associated with running the auction; and
reducing the starting price to a price higher than the minimum price if no bid is received within a particular length of time after the auction is started.

6. The method of claim 1, wherein the discounted price includes:
a first price for a total number of bytes over the time period; or
a second price for a particular bitrate during the time period.

7. The method of claim 1, wherein the discounted price includes:
a first price for best effort traffic;
a second price for prioritized traffic; or
a third price for discard eligible traffic.

8. The method of claim 1, wherein the discounted price includes a first price for a first latency bound and a second price for a second latency bound.

9. The method of claim 1, wherein providing an auction associated with a time period during the predicted trough period includes generating a plurality of auctions for the predicted trough period, the method further comprising:
determining that one or more bids associated with the plurality of auctions will increase bandwidth use during the predicted trough period by at least a particular amount; and
terminating remaining ones of the plurality of auctions, in response to determining that the one or more bids associated with the plurality of auctions will increase bandwidth use during the predicted trough period by the least a particular amount.

10. The method of claim 1, wherein provisioning the one or more services on the network device for the customer includes:
establishing a policy to enforce a limit of at least one of a bit rate or a total number of bytes associated with the bid, wherein the policy performs at least one of dropping packets that exceed the limit or charging a price higher than the discounted price for the packets that exceed the limit.

11. The method of claim 1, wherein provisioning the one or more services on the network device for the customer includes:
provisioning at least one of a policer, an access control list, a label switched path, or a virtual local area network based on a specification received from the customer.

12. The method of claim 1, further comprising:
billing the customer for bandwidth use, associated with the network device, for the duration of the auctioned time period, based on an amount of the bandwidth use.

13. The method of claim 1, further comprising:
de-provisioning the one or more services at the end of the auctioned time period.

14. A system comprising:
a computer device configured to:
obtain bandwidth use data associated with a network device;
predict a trough period in bandwidth use for the network device based on the obtained bandwidth use data;
generate an auction associated with a time period during the predicted trough period, wherein the auction offers use of the network device during the time period at a discounted price;
receive a bid, from a customer, for use of the network device during the time period via the auction; and
provision one or more services on the network device for the customer based on the received bid, wherein the one or more services are provided for a duration of the auctioned time period.

15. The system of claim 14, wherein when predicting the trough period in bandwidth use for the network device, the computer device is further configured to:
identify a trough in the bandwidth use data, wherein the trough occurs at a particular frequency; and
predict the trough period based on the particular frequency.

16. The system of claim 14, wherein the computer device is further configured to:
set a starting price for the discounted price, wherein the starting price is based on a difference in bandwidth use between a predicted bandwidth use during the predicted trough period and a peak bandwidth use;
set a minimum price for the discounted price based on a cost associated with running the auction; and
reduce the starting price to a price higher than the minimum price if no bid is received within a particular length of time after the auction is started.

17. The system of claim 14, wherein when provisioning the one or more services on the network device for the customer, the computer device is further configured to:
provision at least one of a policer, an access control list, a label switched path, or a virtual local area network based on a specification received from the customer.

18. A non-transitory computer-readable medium storing instructions executable by one or more processors, the non-transitory computer-readable medium comprising:
one or more instructions to obtain bandwidth use data associated with a network device;
one or more instructions to predict a trough period in bandwidth use for the network device based on the obtained bandwidth use data;
one or more instructions to generate an auction associated with a time period during the predicted trough period, wherein the auction offers use of the network device during the time period;
one or more instructions to receive a bid, from a customer, for use of the network device during the time period via the auction; and
one or more instructions to provision one or more services on the network device for the customer based on the received bid, wherein the one or more services are provided for a duration of the auctioned time period.

19. The non-transitory computer-readable medium of claim 18, wherein the one or more instructions to generate an auction for a time period during the predicted trough period include one or more instructions to generate a plurality of auctions for the predicted trough period, the non-transitory computer-readable medium further comprising:
one or more instructions to determine that one or more bids associated with the plurality of auctions will increase bandwidth use during the predicted trough period by at least a particular amount; and
one or more instructions to terminate remaining ones of the plurality of auctions, in response to determining that the one or more bids associated with the plurality of auctions will increase bandwidth use during the predicted trough period by the least a particular amount.

20. The non-transitory computer-readable medium of claim 18, wherein the one or more instructions to provision the one or more services on the network device for the customer include:
one or more instructions to establish a policy to enforce a limit of at least one of a bit rate or a total number of bytes associated with the bid, wherein the policy performs at least one of dropping packets that exceed the limit or charging a higher price for the packets that exceed the limit.
